(19) United States
(12) Patent Application Publication
(10) Pub. No.: US 2025/0333113 A1
(43) Pub. Date: Oct. 30, 2025

(54) VEHICLE-BODY REAR STRUCTURE

(71) Applicant: MAZDA MOTOR CORPORATION, Hiroshima (JP)

(72) Inventors: Akihiro NAKATA, Aki-gun (JP); Masaaki BESSHO, Aki-gun (JP); Satoshi OKAMOTO, Aki-gun (JP)

(73) Assignee: MAZDA MOTOR CORPORATION, Hiroshima (JP)

(21) Appl. No.: 19/169,691

(22) Filed: Apr. 3, 2025

(30) Foreign Application Priority Data
Apr. 24, 2024 (JP) 2024-070525

(51) Int. Cl. B62D 25/04; B62D 25/10; B62D 35/00

(52) U.S. Cl. CPC B62D 25/04; B62D 25/10; B62D 35/008

(57) ABSTRACT

There are provided a lid body, a rear pillar, and a duct having a duct-inlet portion and a duct-outlet portion. The duct-inlet portion takes in traveling air flowing down along an outer surface of a vehicle-body side face portion. The duct-outlet portion discharges the traveling air passing through an inside of the rear pillar from a vehicle-body rear face portion. A side spoiler portion protruding rearward from an outward-side point of the duct-outlet portion over a range of a vertical width of the duct-outlet portion is provided, and an outer surface of the side spoiler portion is configured to be smoothly continuous from a rear end of an outer surface of the vehicle-body side face portion and have a rear narrowing angle which is larger than that of the outer surface of the vehicle-body side face portion in a horizontal section.

### BACKGROUND OF THE INVENTION

The present invention relates to a vehicle-body rear structure which comprises a lid body constituting part of a vehicle-body rear face portion and a rear pillar extending in a vertical direction along each of right-and-left side-end side portions of the lid body and constituting part of a vehicle-body side face portion of a vehicle-body rear portion.

As shown in FIG. 11, in the vehicle traveling, traveling airs Wu, Wd which flow down along respective surfaces of a roof portion and an under floor and get separated from respective rear end portions of the surfaces approach to each other, in a vertical direction, downstream because of a negative-pressure zone generated therebetween. Likewise, traveling airs Wl, Wr which get separated from respective rear end portions of surfaces of right-and-left side face portions of the vehicle body approach to each other, in a lateral direction, downstream.

In general, as shown in FIG.11, it has been considered that it is ideal to control the traveling airs Wu, Wd, Wl, Wr such that they gather at a point Pr which is away from the vehicle body by a specified distance, like a rear end of a spindle shape, in order to reduce the air resistance (aerodynamic drag) of the traveling vehicle.

Herein, as shown in FIG. 11, the above-described traveling airs Wu, Wd are easy to control such that they gather at the point Pr because a roof spoiler and a floor undercover prevail in SUV. Accordingly, the aerodynamics measures for the traveling airs getting separated from the rear end portions of the respective surfaces of the roof portion and the under floor seem to have settled down for the normal commercial vehicles.

However, further reduction of the air resistance has been recently demanded from needs to increase the cruising distance of electric vehicles (EV) or the like. Therefore, it may be considered to provide a roof side spoiler which has a long rearward protrusion like the roof spoiler at both sides of the vehicle-body rear face portion in order to improve the aerodynamic performance for respective outer surfaces of the right-and-left side face portions of the vehicle body. However, there was a limit regarding exterior designing of the vehicle in providing the large-sized roof side spoiler at the both sides of the vehicle-body rear face portion.

Thus, as disclosed in Japanese Patent Laid-Open Publication No. 2012-126326 (WO2023185583A1), for example, various measures for properly making the traveling airs getting separated from the rear end portions of the outer surfaces of the right-and-left side face portions of the vehicle body gather at a single point downstream, maintaining the good exterior design of the vehicle-body rear portion, have been devised.

In a side vehicle-body structure of a vehicle of the above-described patent document, there is provided an air-supply route body which comprises a traveling-air inlet port to take in traveling air from a vehicle forward side and a traveling-air discharge port to discharge the taken-in traveling air to a vehicle rearward side are provided at a rear pillar arranged at a side face portion of the vehicle-body rear portion, an air duct as an air-supply route which communicates the above-described inlet port with the above-described discharge port in a longitudinal direction is formed between the air-supply route body and a rear pillar outer of the rear pillar.

The inventors of the present invention have paid attention to the fact that it is effective to deflect the traveling air flowing down toward a vehicle-body central side in a plan view when the traveling air gets separated from a vehicle-body rear end in order to make the traveling airs flowing down along the outer surface of the vehicle-body side face portion gather at a specified single point downstream.

Herein, the side vehicle-body structure of the above-described patent document has a technical idea that the traveling air rearward discharged from the discharge port of the air duct (the air-duct discharge flow) is made to serve as an air curtain in order to prevent the traveling air flowing down along the outer surface of the air-supply route body at the vehicle-body side face portion of the vehicle-body rear portion from flowing into a vehicle rear face (turbulence occurrence). That is, the side vehicle-body structure disclosed in the patent document does not focus on any technical idea of actively deflecting the traveling air flowing down along the vehicle-body side face portion of the vehicle-body rear portion toward the vehicle-body central side in the plan view when the traveling air gets separated from the rear end portion of the vehicle-body side face portion.

### SUMMARY OF THE INVENTION

The present invention has been devised in view of the above-described matter, and an object of the present invention is to provide a vehicle-body rear structure which can properly reduce the air resistance (aerodynamic drag) by making the traveling airs getting separated from the rear end portions of the respective surfaces of the right-and-left side face portions of the vehicle body gather substantially at the specified single point downstream by means of their deflection toward the vehicle-body central side in the plan view.

The present invention is a vehicle-body rear structure comprising a lid body constituting part of a vehicle-body rear face portion, a rear pillar extending in a vertical direction along each of right-and-left side-end side portions of the lid body and constituting part of a vehicle-body side face portion of a vehicle-body rear portion, and a duct-forming member having a duct-inlet portion and a duct-outlet portion and forming a duct to communicate the duct-inlet portion with the duct-outlet portion in a vehicle longitudinal direction, the duct-inlet portion being configured to take in traveling air flowing down along an outer surface of the vehicle-body side face portion on a forward side of the rear pillar, the duct-outlet portion being configured to discharge the taken-in traveling air from the vehicle-body rear face portion, wherein a side spoiler which protrudes rearward from an outward-side point, in a vehicle width direction, of the duct-outlet portion over a range of a vertical width of the duct-outlet portion is provided at a rear side of the duct-forming member, and an outer surface of the side spoiler is configured to be smoothly continuous from a rear end of an outer surface of the vehicle-body side face portion and have a rear narrowing angle which is larger than that (rear-end angle) of the outer surface of the vehicle-body side face portion in a horizontal section.

According to the present invention, both the reduction of the air resistance of the traveling vehicle and the good exterior design of the vehicle-body rear portion can be attained. Specifically, the traveling air (referred to as a “side-face flowing” as well) flowing down along the outer surface of the vehicle-body side face portion of the vehicle-body rear portion (the outer surface of the rear pillar) can be greatly deflected inward, in the vehicle width direction, of the vehicle body through cooperation of the side spoiler having the rear narrowing angle (referred to as a “rear-end angle” as well) which is larger than that of the duct forming member and the air flowing discharged from the duct-out portion.

Accordingly, the traveling airs getting separated from the rear end portions of the respective outer surfaces of the roof portion, the vehicle-body under floor, and the right-and-left vehicle-body side portions (hereafter, referred to as a “vehicle-body passing rear flow” as well) can be made to gather substantially at the rear end of the spindle shape, so that the air resistance of the traveling vehicle can be reduced properly. Further, since the side-face flowing can be greatly deflected inward, in the vehicle width direction, of the vehicle body when getting separated from the rear end portion of the vehicle-body side face portion, suppressing increasing in size of the side spoiler, the good exterior design of the vehicle-body rear portion can be maintained.

In an embodiment of the present invention, the rear narrowing angle of the side spoiler may be set within a range of 25° and more and 29° or less.

According to this structure, the side-face flowing can be greatly deflected inward, in the vehicle width direction, of the vehicle body when getting separated from the rear end portion of the vehicle-body side face portion through cooperation with the ejector effect by means of the air flowing discharged from the duct-outlet portion.

In another embodiment of the present invention, a width of the duct in the horizontal section may be set within a range of 6 mm or more and 40 mm or less.

According to this structure, the air-flowing direction of the side-face flowing can be set at a desired inward-directed angle when the side-face flowing gets separated from the rear end portion of the vehicle-body side face portion.

In another embodiment of the present invention, a quarter window which extends in a longitudinal direction such that a rear end thereof is located at a position of the duct-inlet portion may be provided at a vehicle-body side face positioned between a rear end portion of a side door and the rear pillar, and an outer surface of the quarter window may be inclined such that a rearward side thereof is inclined more.

According to this structure, the quarter window can be utilized as an air-guide plate to actively take the side-face flowing going down along the vehicle-body side face portion into the duct-inlet portion. Further, an air-guide section (section to make a run-up) which is sufficiently long in the longitudinal direction can be formed, maintaining the good-looking vehicle-body side face portion by using the quarter window without providing any other particular air-guide member. That is, the side-face flowing going down rearward along the vehicle-body side face portion can be guided into the duct-inlet portion.

In another embodiment of the present invention, the duct-forming member may comprise a pillar-duct forming member which is provided on an outward side, in the vehicle width direction, of a rear pillar outer of the rear pillar so as to form the duct together with the rear pillar outer therebetween, and the side spoiler may be configured to protrude rearward from a rear end portion of the pillar-duct forming member.

According to this structure, since the rear pillar outer of the rear pillar is used in forming the duct, another member provided at the rear pillar, such as a pillar reinforcement, needs not to have a penetration hole for the duct which is formed additionally. Further, since the pillar-duct forming member and the side spoiler can be formed integrally such that they are continuous in the longitudinal direction, the duct can be easily provided inside the rear pillar, maintaining the superior aerodynamic performance of the side-face flowing.

Thus, the present invention can provide the vehicle-body rear structure which can properly reduce the air resistance of the traveling vehicle, maintaining the good exterior design of the vehicle-body rear portion.

The present invention will become apparent from the following description which refers to the accompanying drawings.

### BRIEF DESCRIPTION OF THE DRAWINGS

FIG. 1 is an exterior view of a vehicle-body rear portion of a vehicle provided with a vehicle-body rear structure of the present embodiment, when viewed obliquely from a rear-left side.

FIG. 2 is a left side view of the vehicle-body rear portion of the vehicle shown in FIG. 1.

FIG. 3 is a sectional view of a major part taken along line A-A of FIG. 2.

FIG. 4 is an enlarged sectional view of a major part of FIG. 3.

FIG. 5 is an exterior view of a duct garnish of the vehicle shown in FIG. 1, when viewed obliquely from a front-outward side.

FIG. 6 is an enlarged exterior view of the vehicle-body rear portion of the vehicle shown in FIG. 1, when viewed obliquely from the rear-left side.

FIG. 7 is a plan view showing traveling airs flowing along an outer surface of a vehicle-body side face portion of the vehicle-body rear portion in vehicle traveling according to the present embodiment.

FIG. 8A is an enlarged left side view of a major part of the vehicle-body rear portion of the vehicle provided with a vehicle-body rear structure according to a modification; FIG. 8B is a sectional view of a major part taken along line B-B of FIG. 8A.

FIG. 9 is a graph showing simulation results of verifying the effectiveness of the vehicle-body rear structure according to the modification.

FIG. 10 is a plan view showing traveling airs flowing along an outer surface of a vehicle-body side face portion of a vehicle-body rear portion of a conventional example.

FIG. 11 is an exterior view of the vehicle-body rear portion of the vehicle, when viewed obliquely from the rear-left side, which explains an ideal situation where the traveling airs getting separated from respective rear end portions of the right-and-left vehicle-body side faces gather at a specified point which is rearward away from the vehicle body.

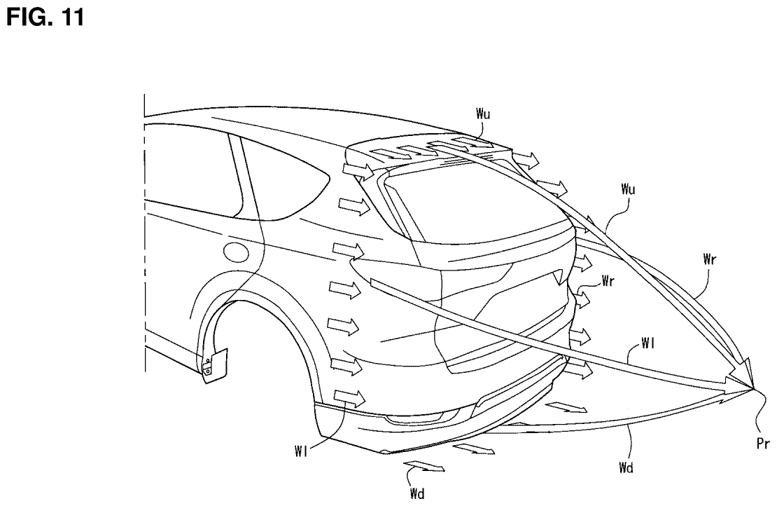

### DETAILED DESCRIPTION OF THE INVENTION

Hereafter, an embodiment of the present invention will be described referring to the drawings.

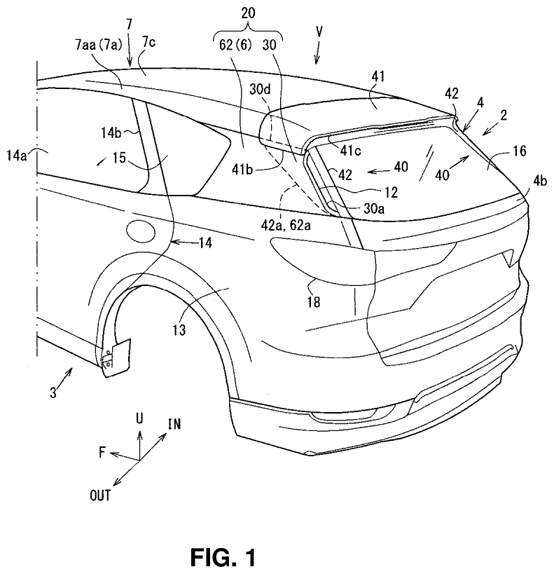

As shown in FIG. 1, a vehicle V provided with a vehicle-body rear structure of the present embodiment is a hatch-back type passenger car which comprises a lift-up type lift gate 4 at a vehicle-body rear face portion 2. In figures, an arrow F shows a vehicle-body front (forward) side, an arrow U shows a vehicle-body upper (upward) side, an arrow OUT shows an outward side, in a vehicle width side, of a vehicle body, and an arrow IN shows an inward side, in the vehicle width side, of the vehicle body. Herein, a lateral direction of the vehicle body is based on a passenger seated in a driver's seat. Further, since right-and-left vehicle-body side face portions 3 of a vehicle-body rear portion of the present embodiment is laterally symmetrical, the left-side vehicle-body side face portion 3 will be described mainly.

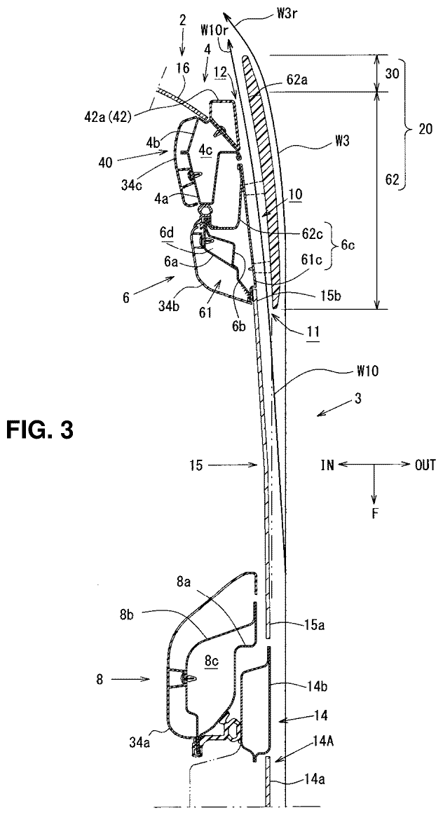

As shown in FIG. 3, a middle pillar 8 and a rear pillar 6 are provided at each of the right-and-left vehicle-body side face portions 3 of the vehicle-body rear portion of the vehicle V of the present embodiment. These pillars 8, 6 are provided to extend in a vertical direction and form part of each of the vehicle-body side face portions 3 of the vehicle-body rear portion, and are separated from each other in a longitudinal direction and support a rear portion of a roof portion 7 which covers over an upper portion of a cabin (see FIG. 1).

The middle pillar 8 is formed by a middle pillar outer 8a and a middle pillar inner 8b which are fixedly joined together, and has a middle-pillar closed-cross section 8c extending in the vertical direction therein.

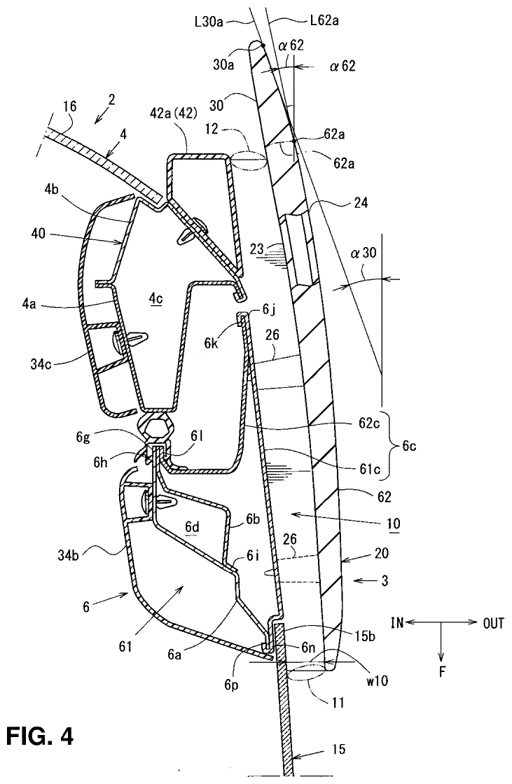

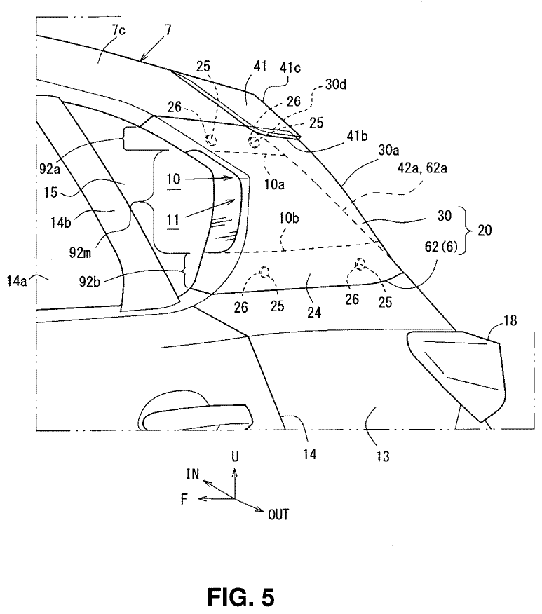

As shown in FIGS. 3 and 4, the rear pillar 6 comprises a rear-pillar body portion 61 and a pillar-duct forming portion 62. The pillar-duct forming portion 62 is arranged on the outward side, in the vehicle with direction, of an outer surface of the rear-pillar body portion 61. A duct 10 is formed between the rear-pillar body portion 61 and the pillar-duct forming portion 62. As shown in FIGS. 4 and 5, the duct 10 has a duct-inlet portion 11 at its front end portion. The duct-inlet portion 11 takes in the traveling air flowing down along an outer surface (a quarter window 15 described later) of the vehicle-body side face portion 3 on a forward side of the rear pillar 6.

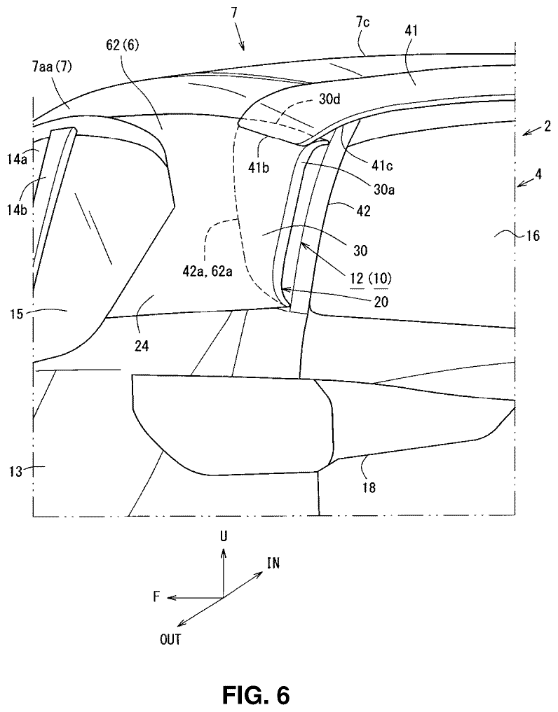

As shown in FIGS. 4 and 6, a duct-outlet portion 12 is provided at a rear end portion of the duct 10. The duct-outlet portion 12 discharges the traveling air passing through an inside of the rear pillar 6 (i.e., inside the duct 10) from each of the right-and-left both sides of the vehicle-body rear face portion 2. That is, the duct 10 communicates the duct-inlet portion 11 with the duct-outlet portion 12 in the vehicle longitudinal direction. The pillar-duct forming portion 62, the duct 10, the duct-inlet portion 11 and the duct-outlet portion 12 will be specifically described later.

As shown in FIG. 4, the rear-pillar body portion 61 comprises a rear pillar inner 6a, a rear-pillar reinforcement 6b, and a rear pillar outer 6c. The rear pillar inner 6a and the rear-pillar reinforcement 6b are joined together at respective inward rear-end flange portions 6g, 6h which are positioned at their inward-side rear ends. A front-end flange portion 6i of the rear-pillar reinforcement 6b is joined to a midway part, in the longitudinal direction and in the vehicle width direction, of the rear pillar inner 6a. Thereby, a rear-pillar closed-cross section 6d extending in the vertical direction is formed between the rear pillar inner 6a and the rear-pillar reinforcement 6b.

The rear pillar outer 6c is a metal-made panel as a non-decoration panel, which comprises a pillar side-face outer panel 61c and a pillar side-end-side outer panel 62c. The pillar side-face outer panel 61c is arranged on the outward side, in the vehicle width direction, of the rear pillar inner 6a and the rear-pillar reinforcement 6b. The pillar side-end-side outer panel 62c is arranged on the rearward side of the rear-pillar reinforcement 6b, and forms a side-end side of each of the right-and-left sides of a rear opening of the cabin (luggage room) at the vehicle-body rear face portion 2. Herein, a rear end portion 6j of the pillar side-face outer panel 61c and an outward end portion 6k of the pillar side-end-side outer panel 62c are joined together.

An inward-side flange portion 6l of the pillar side-end-side outer panel 62c is joined to the inward rear-end flange portion 6g of the rear-pillar reinforcement 6b from an outward side, in the vehicle width direction, of the vehicle body. Further, the pillar side-face outer panel 61c and the rear pillar inner 6a are joined together at their front-end flange portions 6n, 6p.

As shown in FIGS. 1, 2, 5 and 6, the roof portion 7 comprises a pair of right-and-left roof side rails 7a extending longitudinally, a header (not illustrated) interconnecting respective rear end portions of the roof side rails 7a, a roughly rectangular-shaped roof panel 7c covering over a hole area between the pair of roof side rails 7a, and others.

Each of the roof side rails 7a is formed by fixedly joining a roof-side rail outer 7aa and a roof-side rail inner (not illustrated), and the roof side rail 7a has a roof-side closed-cross section (not illustrated) extending in the vehicle longitudinal direction.

The above-described rear header (not illustrated) forms an upper-end side of the rear opening of the cabin (luggage room) at the vehicle-body rear face portion 2, and constitutes a rear-header closed-cross section portion (not illustrated) extending in the vehicle width direction together with the roof panel 7c.

As shown in FIG. 3, a door opening 14A where a rear door 14 is provided is formed between the middle pillar 8 (quarter pillar, C pillar) and a center pillar (B pillar) arranged on its forward side. The rear door 14 is pivotally attached to the center pillar at its front end so as to open and close the door opening 14A. As shown in FIGS. 1-3, a rear door glass 14a is provided at an upper part of the rear door 14, and a door sash portion 14b is provided at a rear end of the rear door 14.

Further, the quarter window 15 (referred to as a “quarter glass” as well) is attached between the middle pillar 8 and the rear pillar 6 (D pillar). The quarter window 15 extends in the longitudinal direction in a roughly straight-line shape, and is provided at a portion of the vehicle-body side face portion 3 which is positioned between the rear pillar 6 and the door sash portion 14b of the rear door 14.

As shown in the horizontal section of FIG. 3, a front end portion 15a of the quarter window 15 is joined to the middle pillar 8 from the vehicle outward side. As shown in FIG. 3, the door sash portion 14b of the rear door 14 which is positioned at the rear end portion of the rear door glass 14a is provided near a front side of the front end portion 15a of the quarter window 15 such that their outer surfaces are smoothly continuous in the longitudinal direction.

Further, as shown in the horizontal section of FIG. 4, a rear end portion 15b of the quarter window 15 is joined to the front-end flange portion 6n of the pillar side-face outer panel 61c of the rear pillar 6 from the vehicle outward side. The pillar side-face outer panel 61c is arranged in back of and adjacently to the rear end portion 15b of the quarter window 15 such that their outer surfaces are smoothly continuous in the longitudinal direction.

Moreover, as shown in the horizontal section of FIG. 3, the outer surface of the rear-pillar body portion 61 (the outer surface of the pillar side-face outer panel 61c) is arranged on the inward side, in the vehicle width direction, of the outer surface of the door sash portion 14b. Accordingly, the quarter window 15 is gently inclined inward in the horizontal-section view such that the rear end portion 15b is located at an inward end, in the vehicle width direction, of the duct-inlet portion 11.

Thereby, the traveling air flowing down along the outer surface of the quarter window 15 in front of the rear pillar 6 can be actively taken into the duct 10 from the duct-inlet portion 11 by utilizing the nature (property) of the traveling air flowing down closely along the outer surface of the vehicle body.

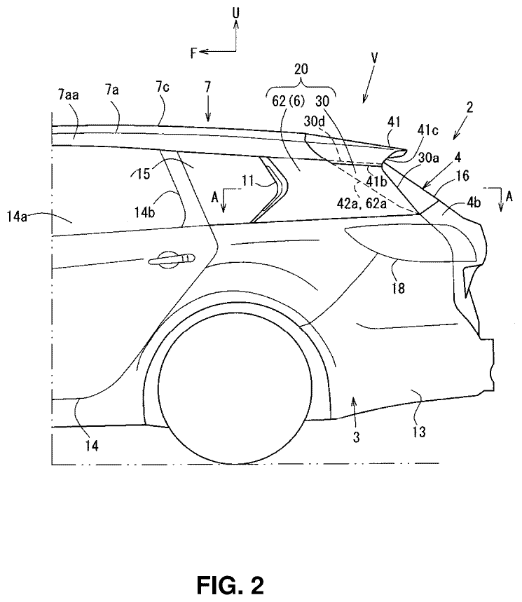

As shown in FIGS. 1 and 2, a rear fender panel 13 is provided in a downstream area of the quarter window 15 and the pillar side-face outer panel 61c at the vehicle-body side face portion 3 of the vehicle-body rear portion such that it is continuous to the rear pillar 6. That is, the quarter window 15 and the pillar side-face outer panel 61c are provided such that their lower ends are positioned at a beltline portion of an upper end of the rear fender panel 13 and their upper ends are positioned at a lower portion of the roof side rail 7a.

Next, the lift gate 4 will be described. The lift gate 4 is configured to open and close a rear luggage opening at the vehicle-body rear face portion 2. The lift gate 4 comprises, as shown in FIG. 1, a metal-made inner panel 4a (see FIG. 4), a metal-made outer panel 4b, a rear window glass 16, a synthetic-resin-made roof spoiler 41, a side garnish 42, and so on, and is formed in a curved shape as a whole such that its upper side is located at a forward side in its side view. The outer panel 4b has an outer surface excluding an upper-end side portion of the lift gate 4, and an inside lamp portion of a rear combination lamp 18, a rear wiper mechanism, and others are installed therein.

Both-side side-end side portions 40 of the lift gate 4 are formed by the metal-made inner panel 4a and the metal-made outer panel 4b which are fixedly joined together, and a closed-cross section 4c extending in the vehicle vertical direction is formed between these panels 4a, 4b. Herein, as shown in FIG. 3, trims 34a, 34b, 34c are provided at respective cabin insides of the middle pillar 8, the rear pillar 6, and the side-end side portions 40 of the lift gate 4. The side-end side portions 40 constitute the right-and-left both sides of the vehicle-body side face portion 2 and also a rear end portion of the vehicle-body side face portion 3.

As shown in FIGS. 1 and 4, the side garnish 42 is attached to the metal-made outer panel 4b of the right-and-left side-end side portions 40 of the lift gate 4 along the side-end side portions 40. A high-mount stop lamp (not illustrated) to light up in synchronization with a stop lamp of the rear combination lamp 18 is installed at the side garnish 42 and a rear portion of the roof spoiler 41.

The side garnish 42 is attached to a rear face of the metal-made outer panel 4b at the side-end side portion 40 of the lift gate 4 via a grommet. An outer surface of the side garnish 42 is smoothly continuous from an outer surface of the pillar side-face outer panel 61c when the lift gate 4 is closed. Herein, the rear pillar 6 extends in the vertical direction along the side-end side portion 40 of the lift gate 4 such that it constitutes part of the vehicle-body side face portion 3 of the vehicle-body rear portion together with the side-end side portion 40 of the lift gate 4.

As shown in FIG. 1, the roof spoiler 41 covers over an upper-end side portion of the rear window glass 16, and constitutes part of the outer surface of the lift gate 4 together with the outer panel 4b. The roof spoiler 41 is formed in a roughly horizontal shape, and protrudes rearward from a rear end portion of the roof panel 7c in the side view.

As shown in FIGS. 1 and 6, right-and-left both end portions of the roof spoiler 41 are configured to curve downward along an extension line of the right-and-left both end portions of the roof side rails 7a in the vehicle back view. Further, as shown in FIGS. 1 and 2, a rear-side end portion extending in the vehicle width direction of the roof spoiler 41 is configured such that its central part is located on a rearward side of its both-side parts. The roof spoiler 41 protrudes rearward such that its upper face has substantially the same level as an upper face of the roof panel 7c without creating any intersection angle therebetween.

Further, as shown in FIGS. 1-6, a duct garnish 20 to deflect the traveling air flowing down along the outer surface of the vehicle-body side end portion 3 toward the inward side, in the vehicle width direction, of the vehicle body at a position of the rear end portion of the vehicle-body side face portion 3 is provided at each of the right-and-left vehicle-body side face portion 3 of the vehicle-body rear portion.

The duct garnish 20 is made by a hollow blow molding of a synthetic resin material and has an appropriate thickness in the vehicle width direction, and is a plate-shaped member extending in the vertical direction and in the longitudinal direction. The duct garnish 20 is comprised of the pillar-duct forming portion 62 and a side spoiler potion 30.

As shown in FIG. 4, the pillar-duct forming portion 62 extends rearward beyond a rear end portion of the rear-pillar body portion 61, i.e., the rear end portion 6j of the pillar side-face outer panel 61c. Specifically, the pillar-duct forming portion 62 extends rearward such that the position of its rear end portion 62a substantially matches, in the vehicle longitudinal direction, the position of a rear end portion of the side-end side portion 40 of the lift gate 4, i.e., a rear end portion 42a of the side garnish 42.

Accordingly, as shown in FIG. 4, the duct 10 is formed in the roughly continuous shape along the longitudinal direction in the horizontal-section view, not only between the pillar-duct forming portion 62 and the rear-pillar body portion 61 but also between the pillar-duct forming portion 62 and the side-end side portion 40 of the lift gate 4, specifically the side garnish 42.

That is, the duct-outlet portion 12 at the rear end portion of the duct 10 is arranged at the same position, in the longitudinal direction, of the rear end portion 42a of the side garnish 42 (see FIG. 4). Further, as shown in FIG. 4, a width w10 of the horizontal section of the duct 10, particularly the width w10 of the duct-inlet portion 11, is set at abut 34 mm which is within a range of 6 mm or more and 40 mm or less.

As shown in FIG. 5, the duct 10 is formed in a middle area 92m, in the vertical direction, of the pillar-duct forming portion 62. At the pillar-duct forming portion 62 are formed a duct upper-wall portion 10a partitioning an upper face of the duct 10 and a duct lower-wall portion 10b partitioning a lower face of the duct 10 at respective upper-and-lower side end portions of the middle area 92m in a longitudinal continuous shape. As shown in FIG. 4, each of the duct upper-wall portion 10a and the duct lower-wall portion 10b is formed over an entire length, in the longitudinal direction, of the pillar-duct forming portion 62, and protrudes inward, in the vehicle width direction, from an inner face (back face) of the pillar-duct forming portion 62 up to its contacting position with respective outer surfaces of the pillar side-face outer panel 61c and the side garish 42 in a rib shape.

Further, as shown in FIGS. 4 and 5, the duct garnish 20 is attached such that the pillar-duct forming portion 62 is attached to the metal-made pillar side-face outer panel 61c from the vehicle outward side via a grommet 26. Specifically, the pillar-duct forming portion 62 is formed in a hollow shape which has an inward wall portion 23 (see FIG. 4) and an outward wall portion 24 (see FIG. 4) in an upper-side area 92a (see FIG. 5) and a lower-side area 92b, and plural grommet attachment portions 25 (see FIG. 5) are provided at the inward wall portion 23 at intervals in the longitudinal direction.

As shown in FIG. 4, the duct garnish 20 is attached to the pillar side-face outer panel 61c so as to form the duct 10 between the both members 20, 61c by inserting the grommets 26 disposed at the grommet attachment portions 25 into penetration holes (not illustrated) which are provided at respective portions of the pillar side-face outer panel 61c which correspond to the grommet attachment portions 25. Herein, as shown in FIG. 5, while the duct 10 of the present embodiment is configured to have substantially the same vertical width over its longitudinal length in the middle area 92m which is one third (⅓), in the vertical direction, of the pillar-duct forming portion 62, the vertical width of the duct may be configured to change along the longitudinal direction or a duct passage may be configured to change vertically.

As shown in FIG. 4, the side spoiler 30 protrudes rearward from the rear end portion 62a of the pillar-duct forming portion 62, which corresponds to an outward side, in the vehicle width direction, of the duct-inlet portion 12, over an entire vertical width of the duct-outlet portion 12. Herein, as shown in FIG. 1, the side spoiler portion 30 of the present embodiment is formed over an entire vertical width of the pillar-duct forming portion 62.

Further, as shown in FIGS. 1, 2, 5 and 6, right-and-left both end portions 41b of the roof spoiler 41 protrude obliquely outward-and-downward until their lower faces contact an upper end portion 30d of the side spoiler portion 30. Respective rear end portions 41c, 30a of the roof spoiler 41 and the side spoiler portion 30 match each other in the vehicle longitudinal direction, and are smoothly continuous from each other in the vertical direction in the vehicle side view.

As shown in the horizontal section of FIG. 4, the outer surface of the side spoiler portion 30 is configured to be continuous reward from the outer surface of the pillar-duct forming portion 62 which forms part of the outer surface of the vehicle-body side face portion 3 of the vehicle-body rear portion and configured such that its rear side is positioned gradually inward.

As shown in the horizontal section of FIG. 4, a tangent line L30a of the rear end portion 30a of the outer surface of the side spoiler portion 30 is inclined relative to the longitudinal direction such that its rearward side is positioned inward more. An angle α30 of the tangential line L30a of the rear end portion 30a of the outer surface of the side spoiler portion 30 relative to the longitudinal direction is defined as a rear narrowing angle α30 (referred to as a “rear-end angle” as well) of the outer surface of the side spoiler portion 30 in the horizontal section.

Likewise, as shown in the horizontal section of FIG. 4, the rear end portion of the outer surface of the vehicle-body side face portion 3 of the vehicle-body rear portion, that is—a tangential line L62a of the rear end portion 62a of the outer surface of the pillar-duct forming portion 62 is inclined relative to the longitudinal direction such that its rear side is positioned gradually inward in the horizonal-section view. An angle α62 of the tangential line L62a of the rear end portion 62a of the outer surface of the pillar-duct forming portion 62 relative to the longitudinal direction is defined as a rear narrowing angle α62 of the outer surface of the pillar-duct forming portion 62 in the horizontal section.

The outer surface of the side spoiler portion 30 is configured to have the rear narrowing angle α30 which is larger than the rear narrowing angle α62 of the outer surface of the pillar-duct forming portion 62 in the horizontal section. In the present embodiment, the rear narrowing angle α62 of the outer surface of the pillar-duct forming portion 62 in the horizontal section is set at 19°, whereas the rear narrowing angle α30 of the outer surface of the side spoiler portion 30 in the horizontal section is set at 25° which is within a range of 25° or more and 29° or less.

The vehicle-body rear structure of the above-described present embodiment comprises, as shown in FIGS. 1-6, the lift gate 4 (lid body) constituting part of the vehicle-body rear face portion 2, the rear pillar 6 extending in the vertical direction along each of the right-and-left side-end side portions of the lift gate 4 and constituting part of the vehicle-body side face portion 3 of the vehicle-body rear portion, and the pillar-duct forming member 62 as a duct forming portion which is provided on the outward side, in the vehicle width direction, of the rear-pillar body portion 61 so as to form the duct 10 therebetween.

As shown in FIGS. 3 and 4, the duct 10 has the duct-inlet portion 11 which is configured to take in the traveling air flowing down along the quarter window 15 which forms part of the outer surface of the vehicle-body side face portion 3 on the forward side of the rear pillar 6. The duct 10 further has the duct-outlet portion 12 configured to discharge the traveling air taken in (see W10 in FIG. 3) from the vehicle-body rear face portion 2. Herein, the duct 10 communicates the duct-inlet portion 11 with the duct-outlet portion 12 in the vehicle longitudinal direction.

Further, as shown in FIG. 4, the rear end portion 62a of the pillar-duct forming portion 62 is positioned on the outward side, in the vehicle width direction, of the duct-outlet portion 12, and the side spoiler portion 30 which protrudes rearward from the rear end portion 62a of the pillar-duct forming portion 62 over a range of the vertical width of the duct-outlet portion 12 is provided at the rear side of the pilar-duct forming portion 62.

Moreover, as shown in FIG. 4, the outer surface of the side spoiler portion 30 is configured to be smoothly continuous from the rear end portion 62a of the outer surface of the pillar-duct forming portion 62 which constitutes part of the vehicle-body side face portion 30 and have the rear narrowing angle α30 which is larger than the rear narrowing angle α62 of the outer surface of the pillar-duct forming portion 62 in the horizontal section.

According to this structure, both the reduction of the air resistance of the traveling vehicle and the good exterior design of the vehicle-body rear portion can be attained. Specifically, the traveling air (referred to as the “side face flow W3” as well) (see FIG. 3) flowing down along the vehicle-body side face portion 3 of the vehicle-body rear portion can be deflected toward the central side, in the vehicle width direction, of the vehicle body when getting separated from the side spoiler portion 30.

Further, the traveling air discharged from the duct-outlet portion 12 (hereafter, referred to as a “duct-passing rear flow W10r” as well) (see FIG. 3) flows faster than the side face flow W3, thereby performing the ejector effect (suction effect) to draw inward in the plan view. This ejector effect can promote the inward-directed deflection of a side-face passing rear flow W3r which has passed through (in other words, has got separated from) the rear end portion 30a of the side spoiler portion 30 and flows down rearward (hereafter, referred to as a “side-face passing rear flow W3r” as well) (see FIG. 3)

That is, the side-face passing rear flow W3r can be deflected greatly inward, in the vehicle width direction, of the vehicle body through cooperation of the side spoiler portion 30 having the rear narrowing angle α30 larger than the rear narrowing angle α62 of the pillar-duct forming portion 62 and the duct-passing rear flow W10r.

Accordingly, the traveling airs getting separated from the rear end portions of the respective outer surfaces of the roof portion 7, the vehicle-body under floor, and the right-and-left vehicle-body side portions 3 (hereafter, referred to as a “vehicle-body passing rear flow” as well) can be made to gather at the rear end of the spindle shape. In other words, the rearward point at which the right-and-left side-face passing rear flows W3r gather can be made to match a rearward point at which the traveling air getting separated from the rear end portion of the upper face of the roof spoiler 41 (hereafter, referred to as a “roof-face passing rear flow” as well) and the traveling air getting separated from the rear end portion of the vehicle-body under-floor surface (hereafter, referred to as an “under-floor passing rear flow” as well) gather. Consequently, the air resistance of the traveling vehicle can be reduced properly.

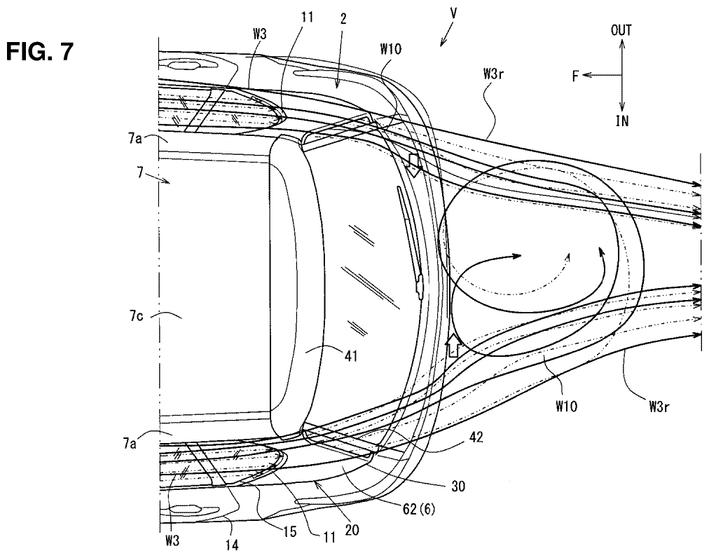

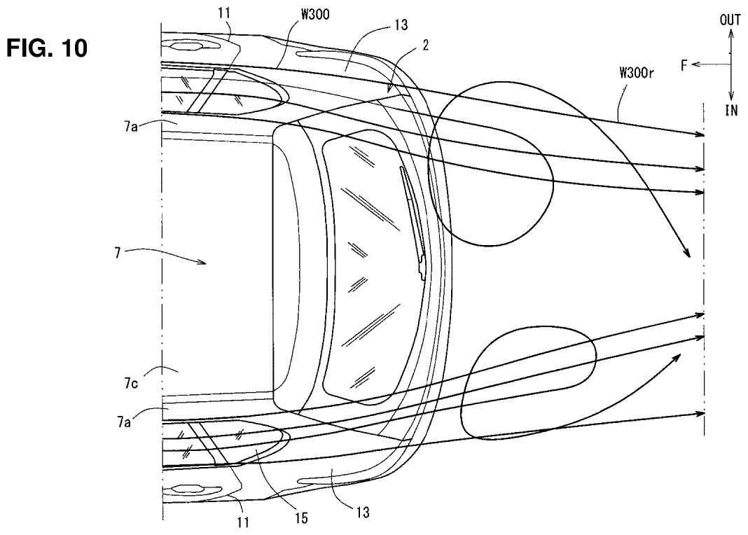

FIG. 7 is a plan view showing the side face flows W3 and the side-face passing rear flows W3r by bold lines, and FIG. 10 is a plan view showing side face flows W300 and the side-face passing rear flows W300r of a conventional example of a vehicle which is not provided with the duct 10 nor the side spoiler portion 30 by bold lines.

As shown in FIG. 7, in the vehicle of the present embodiment, since the function of drawing the side-face passing rear flow W3r inward (ejector effect) is performed by the duct-passing rear flow W10r shown by an imaginary line (see a white arrow in FIG. 7), it can be confirmed that the side-face passing rear flow W3r is deflected inward greatly compared to the side-face passing rear flow W300r of the conventional example of the vehicle shown in FIG. 10.

Further, in the vehicle of the present embodiment, since the inward-directed deflection of the side face flow W3 is not achieved by the side spoiler portion 30 only but the side-face passing rear flow W3r is greatly deflected inward through its cooperation with the duct-passing rear flow W10r as described above, the side spoiler portion 30 can be suppressed from being large-sized and thereby the appropriate exterior design of the vehicle-body rear portion can be maintained. Further, the side spoiler portion 30 can be properly attached to the vehicle body, and the performance of rear-view visibility of a passenger through the rear window glass 16 is not hindered by the side spoiler portion 30.

Also, since the pillar-duct forming portion 62 to form the duct 10 is provided on the outward side of the rear-pillar body portion 61 in cooperation with the rear-pillar body portion 61 in the present embodiment (see FIG. 4), it is unnecessary to form any penetration holes at components of the rear-pillar body portion 61, e.g., the metal-made rear pillar inner 6a, the metal-made rear pillar reinforcement 6b, and the metal-made rear pillar outer 6c, in order to form the duct 10.

That is, the pillar-duct forming portion 62 can be made integrally with the side spoiler portion 30 by synthetic-resin molding as part of the duct garnish 20 such that they are continuous in the longitudinal direction. Accordingly, the pillar-duct forming portion 62 itself and the duct 10 can be easily provided, improving the aerodynamic performance of the side face flow W3.

In the embodiment of the present invention, as shown in FIG. 4, the rear narrowing angle α30 of the side spoiler portion 30 is set within the range of 25° and more and 29° or less. According to this structure, the side-face passing rear flow W3r can be greatly deflected inward, in the vehicle width direction, of the vehicle body through cooperation with the ejector effect by means of the duct passing rear flow W10r.

In the embodiment of the present invention, as shown in FIG. 4, the width w10 of the duct 10 in the horizontal section is set within the range of 6 mm or more and 40 mm or less. According to this structure, the side-face passing rear flow W3r can be set at a desired inward-directed angle.

In the embodiment of the present invention, as shown in FIG. 3, the quarter window 15 which extends in the longitudinal direction such that the rear end 15b is located at the position of the duct-inlet portion 11 is provided at the vehicle-body side face 3 positioned between the rear end portion of the door sash portion 14b of the rear door 14 and the rear pillar 6, and the outer surface of the quarter window 15 is inclined such that its rearward side is inclined more.

According to this structure, the quarter window 15 can be utilized as an air-guide plate to actively take part of the side-face flow W3 into the duct-inlet portion 11. Thereby, the air-guide section (section to make the run-up) which is sufficiently long in the longitudinal direction can be formed, maintaining the good-looking vehicle-body side face portion 3 by using the quarter window 15 without providing any other particular air-guide member.

Further, the quarter window 15 can be provided to be gently inclined such that its rearward side is positioned inward more. Accordingly, the side face flow W3 can be made to flow down rearward stably along the outer surface of the quarter window 15, and the side face flow W3 can be actively taken into the duct-inlet portion 11 by utilizing the nature (property) of the side face flow W3 flowing down closely along the outer surface of the vehicle-body side face portion 3.

In correspondence of the present invention to the above-described embodiment, the lid of the present invention corresponds to the lift gate 4 of the embodiment. Likewise, the side spoiler corresponds to the side spoiler portion 30, and the pillar-duct forming member corresponds to the pillar-duct forming portion 62. However, the present invention is not limited to the above-described embodiment, but any modifications are appliable.

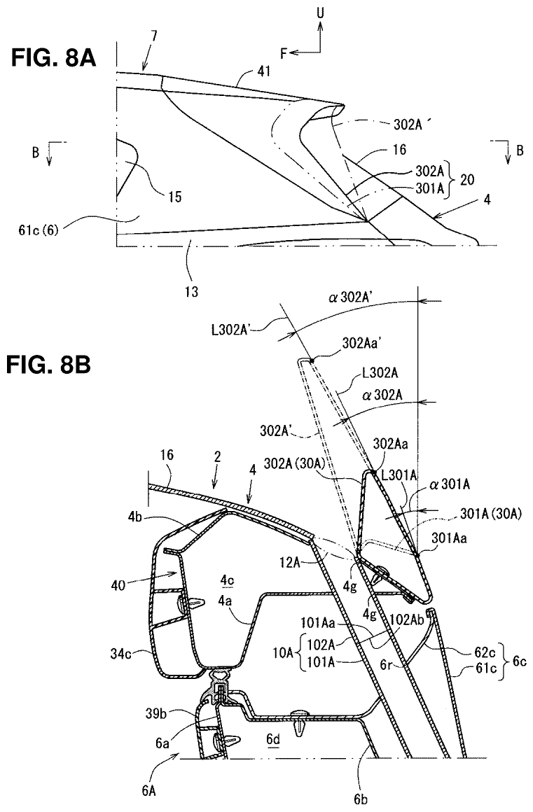

For example, a modification shown in FIGS. 8A and 8B is applicable to the vehicle-body rear structure of the present invention. Hereafter, this modification will be described referring to FIGS. 8A and 8B. The same structures as the above-described embodiment have the same reference characters, and therefore their specific descriptions are omitted here.

The vehicle-body rear structure according to the modification does not have the duct garnish 20 provided on the outward, in the vehicle width direction, of the rear pillar 6, i.e., the pillar-duct forming portion 62, of the above-described embodiment shown in FIG. 4. As shown in FIG. 8B, a duct 10A is formed over a range of a rear pillar 6A and the side-end side portion 40 of the lift gate 4.

The duct 10A of the modification comprises a pillar duct 101A which penetrates longitudinally an inside of the rear pillar 6A and a side-end side portion duct 102A which penetrates longitudinally an inside of the side-end side portion 40. The duct 10A is configured to longitudinally communicate an inlet portion 102Ab positioned at a front end of the side-end side portion duct 102A with an outlet portion 101Aa positioned at a rear end of the pilar duct 101A when the lift gate 4 is closed.

The pillar duct 101A is held in a state where it is inserted into a penetration hole 6r of the rear pillar outer 6c (only the penetration hole 6r of a pillar side-end-side outer panel 62c is illustrated). The side-end side portion duct 102A is held in a state where it is inserted into a penetration hole 4g which penetrates the metal-made inner panel 4a and the metal-made outer panel 4b, respectively.

A duct-inlet portion of the duct 10A of the modification is provided at a front portion of the pillar side-face outer panel 61c, which is not illustrated. Meanwhile, as shown in FIG. 8B, a duct-outlet portion 12A is provided at a portion of the lift gate 4 which is positioned between the side-end side portion duct 102A and the rear window glass 16 in the horizontal-section view.

As shown in FIGS. 8A and 8B, an outward-side portion of the duct-outlet portion 12A is provided with a side spoiler portion 30A in place of the above-described side garnish 42 (see FIG. 4). As shown in FIG. 8B, the side spoiler portion 30A comprises a spoiler base portion 301A which is located at a position corresponding to the side garnish 42 and a rearward protrusion portion 302A which protrudes rearward from a rear end portion 301Aa of the spoiler base portion 301A over a vertical width of the duct-outlet portion 12A, which are formed integrally by synthetic-resin molding.

An outer surface of the side spoiler portion 30A is configured to be smoothly continuous rearward from a rear end portion of the pillar side-face outer panel 61c and such that its rearward side is positioned inward more.

Herein, the rear end portion 301Aa of the spoiler base portion 301A of the side spoiler portion 30A is located at an outward position, in the vehicle width direction, of the duct-outlet portion 12A and also at the rear end portion of the vehicle-body side face portion 3 of the vehicle-body rear portion. Accordingly, a rear narrowing angle α301A of the vehicle-body side face portion 3 of the vehicle-body rear portion of this modification means a rear narrowing angle of the outer surface of the spoiler base portion 301A in the horizontal section, specifically an angle of a tangential line L301A of the rear end portion 301Aa of the outer surface of the spoiler base portion 301A of the side spoiler portion 30A relative to the longitudinal direction.

Further, a rear narrowing angle α302A of the outer surface of the side spoiler portion 30A of this modification means an angle of a tangential line L302A of a rear end portion 302Aa of the outer surface of the rearward protrusion portion 302A of the side spoiler portion 30A relative to the longitudinal direction, which means a rear narrowing angle of the outer surface of the rearward protrusion portion 302A in the horizontal section.

In the modification, the rear narrowing angle α301A of the outer surface of the spoiler base portion 301A is set at 19°. Meanwhile, the rear narrowing angle a302A of the outer surface of the rearward protrusion portion 302A is set at 25° which is within the range of 25° or more and 29° or less.

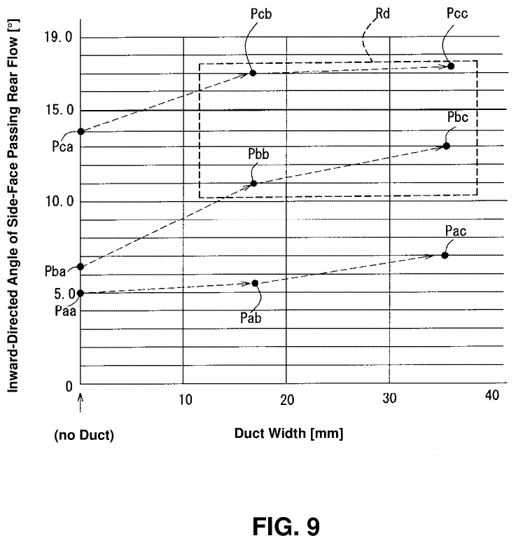

FIG. 9 is a graph showing simulation results of verifying an inward-directed deflection angle, in the horizontal-section view, of the passing rear flow of the rear end portion of the vehicle-body side face portion 3 of the vehicle-body rear portion in the vehicle traveling regarding samples of the present invention according to the rear vehicle-body structure of the modification or its related structure, and a comparative example and a conventional example.

Specifically, the graph of FIG. 9 shows relationships between the horizontal width w10 of the duct 10A and the inward-directed angle of the side-face passing rear flow W3r according to three kinds of rear narrowing angles in the cases where the side spoiler portion 30A was provided or not, and the side spoiler portion 30A was provided. That is, the lateral axis of FIG. 9 shows the horizontal width w10 of the duct 10A, and the vertical axis of FIG. 9 shows the inward-directed angle of the side-face passing rear flow W3r.

An area Rd which is enclosed by a broken line in FIG. 9 is an area where the simulation results obtained under the rear vehicle-body structure of the present invention are to be included. Herein, it is considered that 15° of an inward-directed deflection angle is an ideal angle.

In the conventional example where the duct 10A and the rearward protrusion portion 302A of the side spoiler portion 30A were not provided, the result showing by a plot Paa in FIG. 9 was obtained. Meanwhile, in the conventional example where the duct 10A was provided, the respective results showing by plots Pab, Pac in FIG. 9 were obtained in accordance with 17 mm, 34 mm of the horizontal width w10 of the duct 10A, respectively. That is, as shown in FIG. 9, in the respective conventional examples corresponding to the plots Pab, Pac, the respective inward-directed deflection angles of the side-face passing rear flow W3r were improved more than that of the conventional example corresponding to the plot Paa in FIG. 9, but both of them were below 8° and out of a range of the area Rd.

Further, while the rear narrowing angle of the side spoiler portion was set at 25°, the result shown by a plot Pba in FIG. 9 was obtained in the conventional example where the duct 10A was not provided. That is, as shown in FIG. 9, in the conventional example corresponding to the plot Pba, the inward-directed deflection angle was below 8° and out of the range of the area Rd.

For the above-described conventional example corresponding to the plot Pba, in the samples of the present invention where the duct 10A was provided, the results showing by the plots Pbb, Pbc in FIG. 9 were obtained in accordance with 17 mm, 34 mm of the horizontal width w10 of the duct 10A, respectively. That is, as shown in FIG. 9, in the respective samples of the present invention corresponding to the plots Pbb, Pbc, the respective inward-directed deflection angles of the side-face passing rear flow W3r were improved compared to the above-described conventional example corresponding to the plot Pba and exceeded 8°.

Further, in the comparative example where the duct 10A was not provided but the rear narrowing angle of the side spoiler portion was set at 29°, the result showing by the plot Pca in FIG. 9 was obtained. That is, as shown in FIG. 9, in the comparative sample corresponding to the plot Pca, the inward-directed deflection angle of the side-face passing rear flow W3r exceeded 8°. Herein, in a case where a rear narrowing angle α302A′ of the outer surface of the side spoiler portion was 29° like the comparative example, the rear narrowing angle α302A′ means an angle of a tangential line L302A′ of a rear end portion 302a′ of the outer surface of the side spoiler portion 30A which is provided with a rearward protrusion portion 302A′ shown by a one-dotted broken line in FIG. 8 relative to the longitudinal direction.

Moreover, for the above-described comparative example corresponding to the plot Pca, in the sample of the present invention where the duct 10A was provided, the results showing by the plots Pcb, Pcc in FIG. 9 were obtained in accordance with 17 mm, 34 mm of the horizontal width w10 of the duct 10A. That is, as shown in FIG. 9, in the respective samples of the present invention corresponding to the plots Pcb, Pcc, the respective inward-directed deflection angles of the side-face passing rear flow W3r were improved compared to the comparative example and exceeded 15°.

According to the above-described results shown in FIG. 9, it was confirmed that the cooperation of the side spoiler portion 30A having the larger rear narrowing angle than the conventional side spoiler portion and the duct passing rear flow W10r could deflect the side-face passing rear flow W3r inward greatly.

Particularly, it was confirmed according to the results of the plots Pbb, Pbc in FIG. 9 that the inward-directed deflection angle of the side-face passing rear flow W3r could be improved considerably compared to the conventional example corresponding to the plot Pba, suppressing the rear narrowing angle α302A of the side spoiler portion 30A (the rearward extension length of the rearward protrusion portion 302A) relative to the rear narrowing angle α302A′.

Specifically, as shown in FIG. 8, the rearward protrusion length of the rearward protrusion portion 302A of the side spoiler portion 30A tends to become long when the rear narrowing angle of the outer surface of the side spoiler portion becomes large (see the rearward protrusion portions 302A, 302A′ in FIG. 8). Accordingly, by suppressing the rear narrowing angle α302A (25°) of the side spoiler portion relative to the rear narrowing angle α302A′ (29°) of the side spoiler portion of the example of the present invention corresponding to the plots Pcb, Pcc in FIG. 9 like the example of the present invention corresponding to the plots Pbb, Pbc in FIG. 9, the side spoiler portion 30A can be suppressed from being large-sized (the rearward protrusion length of the rearward protrusion portion 302A). Consequently, the vehicle-body rear face portion 2 can maintain the good external design and the superior attachment performance to the vehicle body.

Further, it was confirmed from the results of the plots Pbb, Pbc, Pcb, Pcc in FIG. 8 that the inward-directed deflection angle of the side-face passing rear flow W3r in the case of 34 mm of the horizontal width w10 of the duct 10A can be improved compared to the case of 17 mm of the horizontal width w10 of the duct 10A. Herein, the present simulation was set such that the vehicle traveled at a constant speed of 140 kph. In a case where the horizontal width w10 of the duct 10A was set at 17 mm under this setting, the air speed at the duct-inlet portion (not illustrated) was 40 kph and the air speed at the duct-outlet portion 12A was 55 kph. Meanwhile, in the case of 34 mm of the horizontal width w10 of the duct 10A, the respective air speeds at the duct-inlet portion and the duct-outlet portion 12 were the same speed of 76 kph.

According to the above-described results, it can be considered that in a case where the horizontal width w10 of the duct 10A was wider, the amount of air flow taken into the duct 10A from the duct-inlet portion 11 increased and thereby the flowing speed of the traveling air flowing through the inside of the duct 10A became faster, so that the flowing speed of the duct passing rear flow W10r increased as well. That is, the above-described results match the consideration that as the speed of the duct passing rear flow W10r increases, the performance of drawing the side-face passing rear flow W3r inward (the ejector effect) improves.

Herein, in correspondence of the present invention to the above-described modification, the side spoiler corresponds to the side spoiler portion 30A, and the duct forming member corresponds to the pillar duct 101A and the side-end side portion duct 102A.

The vehicle-body rear structure of the present invention includes a structure which has the quarter window 15 and the middle pillar 8 at the vehicle-body side face portion 3 of the vehicle-body rear portion. Further, a sash-less type of door in which the rear door 14 does not have the door sash portion 14b at its rear end is included as well.

What is claimed is:

1. A vehicle-body rear structure, comprising:
a lid body constituting part of a vehicle-body rear face portion;
a rear pillar extending in a vertical direction along each of right-and-left side-end side portions of the lid body and constituting part of a vehicle-body side face portion of a vehicle-body rear portion; and
a duct-forming member having a duct-inlet portion and a duct-outlet portion and forming a duct to communicate the duct-inlet portion with the duct-outlet portion in a vehicle longitudinal direction, the duct-inlet portion being configured to take in traveling air flowing down along an outer surface of the vehicle-body side face portion on a forward side of the rear pillar, the duct-outlet portion being configured to discharge the taken-in traveling air from the vehicle-body rear face portion,
wherein a side spoiler which protrudes rearward from an outward-side point, in a vehicle width direction, of said duct-outlet portion over a range of a vertical width of the duct-outlet portion is provided at a rear side of said duct-forming member, and an outer surface of said side spoiler is configured to be smoothly continuous from a rear end of an outer surface of the vehicle-body side face portion and have a rear narrowing angle which is larger than that of said outer surface of the vehicle-body side face portion in a horizontal section.

2. The vehicle-body rear structure of claim 1, wherein the rear narrowing angle of said side spoiler is set within a range of 25° and more and 29° or less.

3. The vehicle-body rear structure of claim 2, wherein a width of said duct in the horizontal section is set within a range of 6 mm or more and 40 mm or less.

4. The vehicle-body rear structure of claim 1, wherein a quarter window which extends in a longitudinal direction such that a rear end thereof is located at a position of said duct-inlet portion is provided at a vehicle-body side face positioned between a rear end portion of a side door and said rear pillar, and an outer surface of said quarter window is inclined such that a rearward side thereof is inclined more.

5. The vehicle-body rear structure of claim 1, wherein said duct-forming member comprises a pillar-duct forming member which is provided on an outward side, in the vehicle width direction, of a rear pillar outer of said rear pillar so as to form said duct together with the rear pillar outer therebetween, and said side spoiler is configured to protrude rearward from a rear end portion of said pillar-duct forming member.

6. The vehicle-body rear structure of claim 3, wherein a quarter window which extends in a longitudinal direction such that a rear end thereof is located at a position of said duct-inlet portion is provided at a vehicle-body side face positioned between a rear end portion of a side door and said rear pillar, and an outer surface of said quarter window is inclined such that a rearward side thereof is inclined more.

7. The vehicle-body rear structure of claim 3, wherein said duct-forming member comprises a pillar-duct forming member which is provided on an outward side, in the vehicle width direction, of a rear pillar outer of said rear pillar so as to form said duct together with the rear pillar outer therebetween, and said side spoiler is configured to protrude rearward from a rear end portion of said pillar-duct forming member.
